(19) United States
(12) Patent Application Publication
(10) Pub. No.: US 2021/0147138 A1
(43) Pub. Date: May 20, 2021

(54) CAPSULE FOR PREPARING A BEVERAGE PRODUCT

(71) Applicant: DELICA AG, Birsfelden (CH)

(72) Inventors: Roland AFFOLTER, Möriken (CH); Tim THILLA, Weil am Rhein (DE); Markus BRÖNNIMANN, Hermrigen (CH)

(21) Appl. No.: 16/492,277

(22) PCT Filed: Jan. 31, 2018
(86) PCT No.: PCT/EP2018/052345

§ 371 Date: Sep. 9, 2019

(30) Foreign Application Priority Data
Mar. 10, 2017 (EP) 17160248.5

(51) Int. Cl. B65D 85/804; A47J 31/40

(52) U.S. Cl. CPC B65D 85/8043; A47J 31/4492; A47J 31/407

(57) ABSTRACT

The invention relates to a capsule for preparing a beverage product. The capsule comprises a capsule body, a lid, and an inlet for introducing a fluid into the capsule. The capsule body is covered by the lid to form a closed receiving chamber, and the inlet is arranged eccentrically on the capsule in relation to a center of the cover. A first machine readable code is eccentrically applied to, in particular printed on, the lid. In relation to the center of the lid, the first machine-readable code. in particular the center thereof, is arranged at an angular spacing relative to the inlet. The angular spacing has a magnitude of at most 70°, preferably at most 60°, preferably at most 50°.

This application is a National Stage completion of PCT/EP2018/052345 filed Jan. 31, 2018, which claims priority from European patent application serial no. 17160248.5 filed Mar. 10, 2017.

### FIELD OF THE INVENTION

The present invention relates to a capsule for preparing a beverage product.

### BACKGROUND OF THE INVENTION

A multiplicity of different portion packs and systems for producing beverages are known in the prior art. In particular, capsules are frequently used for preparing different hot beverages, especially coffee or tea, in the home. Such capsules, which are designed as disposable products, conventionally comprise a capsule body for receiving the beverage ingredients and a cover covering the capsule body. The ingredients are generally roasted and ground coffee beans, but sometimes are also dried tea leaves. However, soluble products in general or concentrates are also suitable. During the actual preparation, pressurized water is conducted through the capsule, as a result of which the material contained in the chamber is extracted or dissolved.

So that capsules having different contents (for example various types of coffee or tea, soluble products, or concentrates) can be used with one and the same device, there is a need to set the operating parameters of the device depending on the respectively used product. This relates, for example, to the quantity of liquid to be conducted through, to the extraction temperature or else to the extraction speed. For safety reasons, the intention furthermore is to prevent the machine being operated with incompatible capsules.

For this purpose, it is already known in principle to provide a portion pack with an identifier and a beverage preparation device having means for sensing said identifier. WO 2005/079638 A1 thus describes a beverage production system with a capsule, on The cover of which a machine-readable code is mounted. The code is arranged eccentrically with respect to a center of the cover and furthermore is positioned at a minimum angle spacing of 70° from a likewise eccentrically arranged inlet for introducing a fluid into the capsule. It can thereby supposedly be avoided that a distortion of the cover in a region where the latter is penetrated has an effect on the readability of the code. In addition, it is prevented that small quantities of liquid which escape in the region of the inlet during preparation of a beverage impair the readability of the code.

However, this configuration of the capsule makes it necessary for an outlet with a filter element to have to be provided next to the inlet, specifically for coffee beverages. The formation of a filter surface on the cover of the capsule, for example by multiple penetration of said cover, is not possible in particular for two reasons: firstly, a filter surface should not be arranged too close to the inlet since this can potentially lead to a liquid which is introduced through the inlet into the capsule flowing immediately out again. Secondly, the large angle spacing of the machine-readable code from the inlet covers regions of the cover that could in principle be used as a filter surface. Using a region with a mounted code simultaneously as a filter surface is not a favorable option since this would impair the readability of the code during the preparation of a beverage.

### SUMMARY OF THE INVENTION

It is therefore the object of the present invention to overcome the abovementioned disadvantages in the prior art. In particular, it is an object of the invention to provide a capsule for the preparation of a beverage product, in which, despite the presence of a machine-readable code on the cover, a sufficiently large filter surface can be provided. Furthermore, the intention is to avoid a liquid which has been introduced into the capsule through the inlet immediately flowing out again via a filter surface formed on the cover.

These objects are achieved by a capsule which has the features in the independent claim(s). The capsule for preparing a beverage product comprises a capsule body, a cover and an inlet for introducing a fluid into the capsule. The capsule body is covered by the cover in order to form a closed receiving space, and the inlet is arranged eccentrically on the capsule with respect to a center of the cover. A first machine-readable code is attached eccentrically, in particular printed, on the cover. The first machine-readable code, in particular the center thereof is arranged with respect to the center of the cover at an angle spacing α from the inlet. The angle spacing α has a value of at most 70°, preferably at most 60°, preferentially at most 50°.

The center of the cover is formed in particular by the geometrical center of gravity thereof.

By means of the arrangement according to the invention of the inlet and of the first machine-readable code on the capsule, the portion of the surface of the cover that can be used as a filter surface is significantly increased. It has been shown surprisingly—and contrary to the observations in the prior art—that a small angle spacing between the inlet and the machine-readable code does not have any negative effects on the readability of said code. Firstly, in the case of commonly used materials for the cover, only a slight distortion of same due to penetration could be established. Secondly, small quantities of liquid which escape in the region of the inlet during preparation of a beverage do not appear to impair the readability of the code. Among the reasons for this is that said liquid is primarily water provided by the beverage preparation device. Said water, because of its transparency, does not have any negative influence on the readability of the code. Under some circumstances, the water can even lead to impurities which have been deposited on the code being rinsed away by the water. An advantage of the configuration according to the invention of the capsule is that there is more design freedom with respect to the position and the size of the filter surface because of the compact arrangement of the inlet and of the first machine-readable code on the cover. As a result, a filter surface can be provided only in a size required for coffee beverages, depending on the type of coffee beverage. Furthermore, this can effectively avoid liquid which has been introduced into the capsule through the inlet immediately flowing out again through a filter surface formed on the cover.

A second machine-readable code is mounted eccentrically, in particular printed, on the cover next to the first machine-readable code. The first machine-readable code, in particular the center thereof, can be arranged with respect to the center of the cover at a positive angle spacing α, and the second machine-readable code, in particular the center thereof, can be arranged at a negative angle spacing α′ from the inlet. The angle spacings α and α′ can have a value of at most 70°, preferably at most 60°, preferentially at most 50°. By means of this embodiment of the capsule, the abovementioned advantages with respect to the arrangement of the inlet and of the machine-readable code are extended from one code to two.

The value of the first and second angle spacing α and α′ here can be identical in size. This arrangement has proven particularly advantageous because of its symmetry.

The capsule body can have a recess in an edge region. The angle spacing β of the recess from the inlet with respect to the center of the cover can have a value of at least 90°, preferably at least 120°, preferentially at least 130°. Such a recess can serve to define the orientation of the capsule in a beverage preparation device. An angle spacing of recess and inlet results in more flexibility with respect to the configuration of the capsule and of the beverage preparation device.

The inlet can be arranged in the interior of the receiving space. In particular, the inlet can adjoin the cover and can preferably be closed by the latter. The distribution of a liquid introduced into the capsule within said capsule can thereby be improved.

It goes without saying, however, that the inlet can also be formed merely by a region of the cover that is penetrated during use of the capsule with a beverage preparation device. There is no need here for said region on the cover to be marked.

The at least one machine-readable code can be a one-dimensionally machine-readable code, in particular a barcode, a two-dimensionally machine-readable code or an RFID code.

If the at least one machine-readable code is a barcode, the latter can be standardized. For example, it can be a trade barcode (EAN, UPC, IAN, JAN), a 2/5 code, a code 39, a code 93, a codabar, or a code 128. Such codes are widespread in the prior art. They have a high degree of reliability in conjunction with the sensing thereof, and a series of different systems is available with which they can be read.

However, it goes without saying that the one-dimensionally machine-readable code does not have to be a conventional barcode. The code can thus have, for example, any desired shapes, including even a wavy shape. Furthermore, the code may also be masked by an outer contour.

If the code is a two-dimensionally machine-readable code, it can be a stacked code, for example a codablock, a code 49, or a PDF417. However, matrix codes, such as a QR code, a data matrix, a maxicode or an aztec code are also suitable. However, point codes or composite codes are also suitable. However, all further optoelectronically readable typefaces and color markings or tactile codings are also suitable for use in combination with the present invention.

At least one one-dimensionally machine-readable code can contain parameters for preparing the beverage product and/or can be linked to said parameters. The parameters can be selected in particular from a list consisting of temperature, volume, flow rate and composition of a liquid to be introduced into the capsule. As a result, when the capsule is placed into a beverage preparation device, the operating parameters of the latter can be adapted. This makes it possible to prepare various beverages with the beverage preparation device. However, the one-dimensionally machine-readable code cannot just contain parameters which remain constant during the preparation of a beverage, and/or can be linked to said parameters. It is likewise possible for the at least one one-dimensionally machine-readable code to contain a beverage preparation routine and/or to be linked thereto. Thus, the flow rate through the capsule during preparation of coffee can vary, for example: first 100%, then 0% (prebrewing), later 60%. This permits in particular the production of a higher quality coffee beverage.

The cover can be formed from a composite structure, in particular comprising an aluminum foil and a nonwoven material. The aluminum foil imparts the tightness to the composite structure that is required in order to hermetically close the capsule body. By means of the use of a nonwoven material in the composite structure, a filter function can additionally be obtained when the aluminum foil is penetrated or burst. Alternatively to said composite structure, a plastics film can also be used.

The capsule can contain a dry substance, in particular a coffee powder, or else also a liquid concentrate. The capsule body can be proportioned along its longitudinal center axis in compressed or extended form. As a result, the shape of the capsule body can be adapted to the respective use, in particular in respect of the substance volume to be accommodated and/or the pressure of the liquid to be introduced, for example during extraction of the capsule content. The capsule body can be produced from a plastics material, in particular by injection molding or thermoforming. These materials and methods have proven successful for producing capsule bodies.

The outer casing of the capsule, namely the capsule body and the cover, can be oxygen- and/or aroma-tight. By means of an oxygen-tight design of the outer casing, penetration of oxygen into the capsule during the storage of a starting substance contained therein can be substantially avoided. In a corresponding manner, aging of the starting substance, for example coffee powder, due to oxidation can be avoided. An oxygen-tight capsule is generally also aroma-tight. Flavorings contained in the starting substance are therefore substantially prevented from escaping during the storage of said starting substance inside the capsule.

Oxygen- and/or aroma-tightness is required in order, particularly in the case of coffee, to achieve a shelf life of 12 months, preferably 18 months. Accordingly, in the present connection, an oxygen- and/or aroma-tight capsule is understood as meaning a capsule in which coffee powder can be stored for a duration of at least 12 months, preferably at least 18 months, at room temperature in atmospheric air without a change to the coffee powder occurring that would significantly impair the quality of a coffee beverage produced therefrom.

The capsule body or the entire capsule can have a surface-modified oxygen transmission rate (OTR) in cm³ per m² per day per 0.21 bar of less than 20, preferably less than 10, preferentially less than 5. The OTR indicates what amount of oxygen per surface and time unit diffuses through the capsule body.

Furthermore, the present invention relates to a beverage preparation system comprising a capsule as described above and a beverage preparation machine. The beverage preparation machine has a receptacle with at least one reading device, the capsule can be inserted into the receptacle and at least one machine-readable code can be read using the at least one reading device.

The reading device can be designed here as at least one barcode scanner, in particular as two barcode scanners arranged at right angles to each other. This makes it possible for a one-dimensionally machine-readable code to be able to be read in every orientation of the capsule relative to the reading device. However, the receptacle of the beverage preparation machine can also have a recess for a tab of the cover of the capsule. Alternatively thereto, the receptacle can also be configured in such a manner that the capsule can only be inserted into the receptacle in one orientation because of the shape of the capsule body or of extensions attached thereto. This facilitates the reading of a code on the capsule since this can take place in a previously defined direction.

However, it is also possible for the reading device to be designed as a camera system. With such a camera system, the one-dimensionally machine-readable code can be reliably read in any orientation with respect to the reading device.

An above-escribed beverage preparation system can additionally comprise an adapter. In order to introduce a liquid into the capsule and in order to discharge a liquid from the capsule, the adapter can be placed together with said capsule into the beverage preparation device. The adapter can have a capsule side on which means for introducing a liquid into the capsule and means for discharging a liquid from the capsule are arranged. The adapter can furthermore have a device side on which an inlet for a liquid provided by the beverage preparation device and also an outlet are arranged. The inlet can be fluidically connected to the means for introducing the liquid into the capsule and the outlet can be fluidically connected to the means for discharging the liquid from the capsule. The adapter can be substantially disk-shaped.

The adapter has the advantage that both the introduction of liquid into the capsule and the discharging of same from the capsule take place on only one side of the capsule. The adapter thus does not have to completely enclose the capsule and can be designed to be structurally significantly simpler. A complicated placing of the capsule into the adapter and later removal of said capsule therefrom is dispensed with. Furthermore, it is possible within certain limits to use capsules of different size and configuration with one and the same adapter since the size and shape of the capsule are not fixedly predetermined by said adapter. This makes it possible, inter alia, to adapt the quantity of a starting substance used with a capsule to the respective recipe in order to prepare a beverage.

The capsule side can have an introducing region, in which the means for introducing the liquid into the capsule are arranged, and/or a discharging region, in which the means for discharging the liquid from the capsule are arranged. The introducing region and/or the discharging region can be bounded by at least one sealing element by means of which at least one tight connection to a contact surface of the capsule can be produced. As a result, an unintentional escape of liquid at the transition from the adapter to the capsule during the production of beverages can be effectively avoided. In particular, the introducing region and the discharging region can be separated from each other by at least one sealing element by means of which a tight connection to the contact surface of the capsule can be produced. An undesirable overflowing of liquid from the introducing region into the discharging region without passing through the capsule can thereby be effectively avoided.

The adapter, optionally including the sealing element, can be produced as a single piece, in two pieces or else three pieces, in particular by injection molding, preferably from a plastics material. By means of the single-piece design, the structural complexity of the adapter is further reduced, as a result of which the latter can be produced more cost-effectively. In particular, injection molding is very readily suitable for mass production.

The means for introducing the liquid into the capsule can be designed as at least one penetration element for penetrating the contact surface of the capsule. As a result, a liquid path into the capsule can be produced in a reliable manner. In particular, the means for introducing the liquid into the capsule can be designed as at least one hollow cannula. Such a hollow cannula is particularly readily suitable for introducing a liquid into the capsule since, after penetrating the contact surface, the liquid can be conducted through the hollow cannula into the interior of the capsule. However, the at least one penetration element can also be selected from a list consisting of a pyramid, a cone, a truncated pyramid, a truncated cone, a cylinder and a prism.

The at least one penetration element can be designed in such a manner that, when the capsule and the adapter are placed into the beverage preparation device and the device is closed, the contact surface of the capsule can be penetrated by the at least one penetration element. As a result, the penetration of the contact surface can be facilitated for the user since said penetration can take place using the beverage preparation device when the actual capsule holder is closed. Furthermore, the capsule is opened only immediately before the preparation of a beverage, which effectively avoids contamination or leaking of the contents thereof.

The means for discharging the liquid from the capsule can be designed as at least one, preferably a plurality of, penetration element(s), in particular selected from a list consisting of pyramids, cones, truncated pyramids, truncated cones, cylinders and prisms, for penetrating the contact surface of the capsule. Such penetration elements constitute an effective means for penetrating the contact surface and therefore for producing a liquid path for discharging the liquid from the capsule. If a plurality of penetration elements are used, the contact surface can be penetrated at a plurality of points. It has been established that the undesirable formation of preferred liquid paths within the starting substance in the interior of the capsule (what is referred to as channeling) can be avoided by the multiple penetration of the contact surface. As a result, good percolation of the starting substance contained in the capsule can be ensured.

The means for discharging the liquid from the capsule can be designed, in particular additionally, as at least one, preferably a plurality of, supporting element(s), in particular selected from a list consisting of pyramids, cones, truncated pyramids, truncated cones, cylinders and prisms. The at least one supporting element can be designed in such a manner that, after the capsule and the adapter are placed into the beverage preparation device, the contact surface of the capsule rests on the supporting element. By means of an internal pressure of the capsule that is built up during preparation of a beverage, the contact surface can then be brought to burst. In this manner, in particular in the case of coffee beverages, particularly high quality can be obtained since the liquid is first introduced into the capsule and the starting substance is wetted by compression of the air contained in the capsule before a liquid path is created for discharging the liquid from the capsule. Furthermore, the burst and optionally additionally also penetrated contact surface can likewise take on the function of a filter element.

The means for discharging the liquid from the capsule, the outlet and optionally also the discharging region can be arranged in the center of the adapter. This makes it possible that, depending on the design of the beverage preparation machine, a receptacle for the prepared beverage, for example a coffee cup, can be placed in a manner centered directly below the adapter and the capsule.

The means for introducing the liquid into the capsule, the inlet and optionally also the introducing region can be arranged in an edge region of the adapter. The means for introducing a liquid into the capsule are preferably designed here as an in particular encircling duct or a channel. As a result, the center of the adapter can be kept free for other parts. Furthermore, when, for example, a plurality of puncture cannulas are used, better distribution of the liquid over the starting substance contained in the capsule can be obtained.

The capsule side of the adapter can have a structure for securing and/or positioning the capsule. Said structure can be configured in the form of an encircling collar. Such a structure ensures that the adapter is positioned correctly on the capsule for preparing the beverage. If the structure is additionally also designed for securing the capsule, adapter and capsule can be connected to each other before the preparation of the beverage and can be placed together as a unit into the beverage preparation device. This simplifies the handling of the adapter by a user.

The collar preferably comprises an indentation for engaging in a recess of the capsule. A desired mutual orientation of adapter and capsule can thereby also be ensured.

The structure can have latching means, in particular in the form of a cavity and/or a latching lug, to which the capsule can be latched, in particular at a flange-like edge, preferably at an encircling collar. The capsule can therefore be held in a standby position in which the contact surface of the capsule is held directly in front of the above-described penetration elements, wherein the contact surface of the capsule is penetrated only when the capsule and the adapter are placed into the beverage preparation device and the device is closed.

The outflow can have a constriction, in particular a gap, for frothing a liquid discharged from the capsule. By means of this configuration of the outflow, an increased shearing action can be obtained during the passage of a liquid. In particular during the production of coffee beverages, this permits an improved crema, as is typical in particular of espresso beverages. If the constriction is designed in the form of a gap, this can additionally administer the function of a valve which opens only as the liquid pressure within the capsule increases and therefore prevents premature escape of the beverage. This permits in particular prebrewing of a starting substance in order to prepare a coffee beverage. The adapter accordingly avoids dispensing of the liquid drop by drop and permits only continuous dispensing. In particular, dripping of liquid after a beverage has been prepared can be avoided if the capsule is removed together with the adapter from the beverage preparation device.

The adapter can have at least one window through which a machine-readable code mounted on the contact surface of the capsule can be read by the beverage preparation device, in particular for setting the operating parameters thereof, when the adapter is placed together with the capsule into the beverage preparation device. This configuration of the adapter ensures that, when a capsule is used, the correct parameters are always set at the beverage preparation device irrespective of the type of adapter used. Confusion which could result in the setting of erroneous operating parameters at the beverage preparation device is therefore effectively avoided.

Alternatively to the above-described design, the adapter can also be formed so as to be transparent at least in regions such that a machine-readable code mounted on the contact surface of the capsule can be read by the beverage preparation device, in particular for setting the operating parameters thereof, when the adapter is placed together with the capsule into the beverage preparation device.

### BRIEF DESCRIPTION OF THE DRAWINGS

Further advantages and individual features of the present invention emerge from the description below of a plurality of exemplary embodiments and from the drawings, in which, schematically:

FIGS. 1 and 2: show schematic illustrations of the capsule body of a capsule according to the invention;

FIG. 3: shows a perspective illustration of a capsule according to the invention;

FIG. 4: shows a top view of a capsule according to the invention;

FIG. 5: shows a top view of an adapter for use with a capsule according to the invention from the capsule side;

FIG. 6: shows a top view of an adapter for use with a capsule according to the invention from the device side;

FIG. 7: shows a perspective illustration of an adapter for use with a capsule according to the invention from the capsule side;

FIG. 8: shows a perspective illustration of an adapter for use with a capsule according to the invention from the device side;

FIG. 9: shows a perspective overall view of a capsule according to the invention and of an adapter provided for use with said capsule;

FIGS. 10 and 11: show perspective illustrations of a capsule according to the invention, placed onto an adapter;

FIG. 12: shows a sectional view through a capsule according to the invention, placed onto an adapter according to FIGS. 9 and 10;

FIG. 13: shows an enlargement of the partial region A from FIG. 12;

FIG. 14: shows an alternative sectional view of a capsule according to the invention, placed onto an adapter according to FIGS. 9 and 10;

FIG. 15: shows an enlargement of the partial region B from FIG. 14;

FIG. 16: shows a perspective overall view of a capsule according to the invention, an adapter provided for use with said capsule and of a beverage preparation device (partially illustrated);

FIG. 17: shows a perspective sectional view of an overall view according to FIG. 16;

FIGS. 18 and 19: show sectional views of a capsule according to the invention, placed onto an adapter, placed into a beverage preparation device (partially illustrated) provided for this purpose;

FIG. 20: shows alternative embodiments of an adapter for use with a capsule according to the invention;

FIG. 21: shows a perspective sectional view of a further exemplary embodiment of an adapter;

FIG. 22: shows a sectional view of the adapter according to FIG. 21 with a capsule placed thereon;

FIG. 23: shows an enlargement of the partial region C from FIG. 22;

FIG. 24: shows a further sectional view of the adapter according to FIG. 21 with a capsule placed thereon;

FIG. 25: shows an enlargement of the partial region D from FIG. 24.

### DETAILED DESCRIPTION OF THE PREFERRED EMBODIMENTS

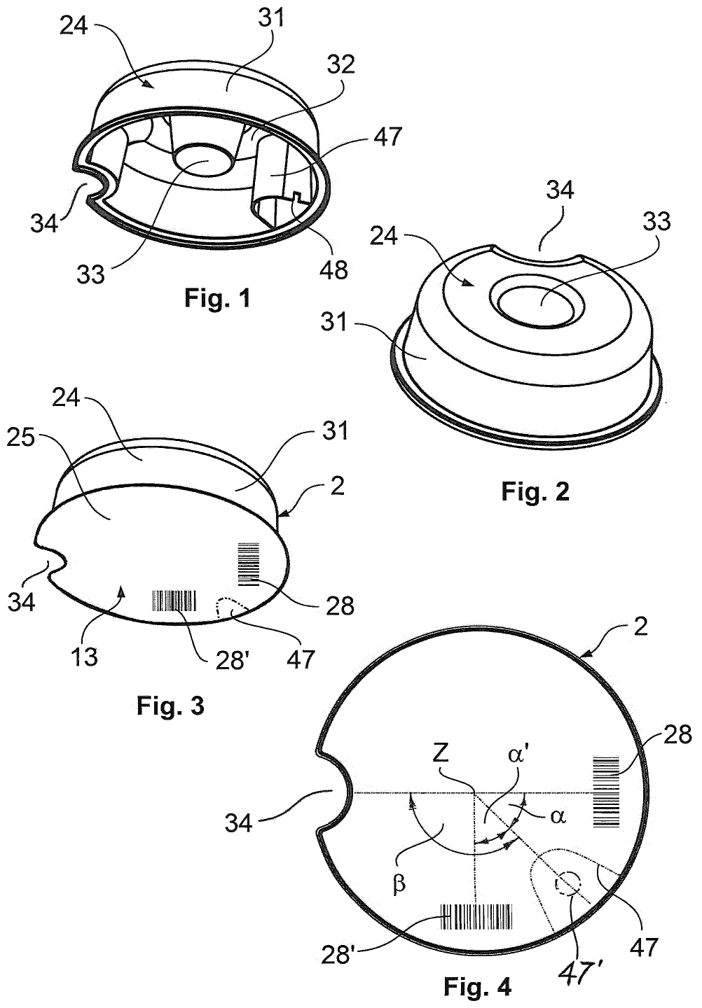

FIGS. 1 and 2 show a capsule body 24 for a capsule 2 according to the invention from two different perspectives. The capsule body 24 comprises a side wall 31 and a base 32. The base 32 has a circular elevation 33. Furthermore, the side wall 31 and part of the base 32 are provided with a recess 34. The interior of the capsule body 24 has an inlet 47. The inlet 47 has a slot 48 on its end side.

FIG. 3 shows a capsule 2 according to the invention in the mounted state. The capsule body 24 is closed by a cover 25 which forms a contact surface 13 of the capsule 2. Two barcodes 28, 28′ are printed on the cover 25. The capsule body 24 together with the cover 25 forms a receiving space for receiving a starting substance for producing a beverage. An inlet 47 which is illustrated by chain-dotted lines in the present illustration is arranged in the receiving space. In order to introduce a liquid into the inlet 47, the cover 25 of the capsule 2 has to be penetrated.

FIG. 4 shows a top view of a capsule 2 according to the invention from the side of the cover. A first barcode 28 and a second barcode 28′ are arranged on the cover. In addition, the inlet 47 is illustrated by chain-dotted lines similarly as in FIG. 3. In addition, 47′ also indicates an inlet which is not visible on the cover surface, as arises in the beverage preparation machine. It can be seen that the center of the first machine-readable code 28 is arranged with respect to the center Z of the cover at an angle spacing of α +50° from the inlet 47. The second machine-readable code 28′ is arranged at an angle spacing of α −45° from the inlet 47. The capsule furthermore has a recess 34. The inlet 47 is arranged with respect to the center Z of the cover at an angle spacing β of 130°.

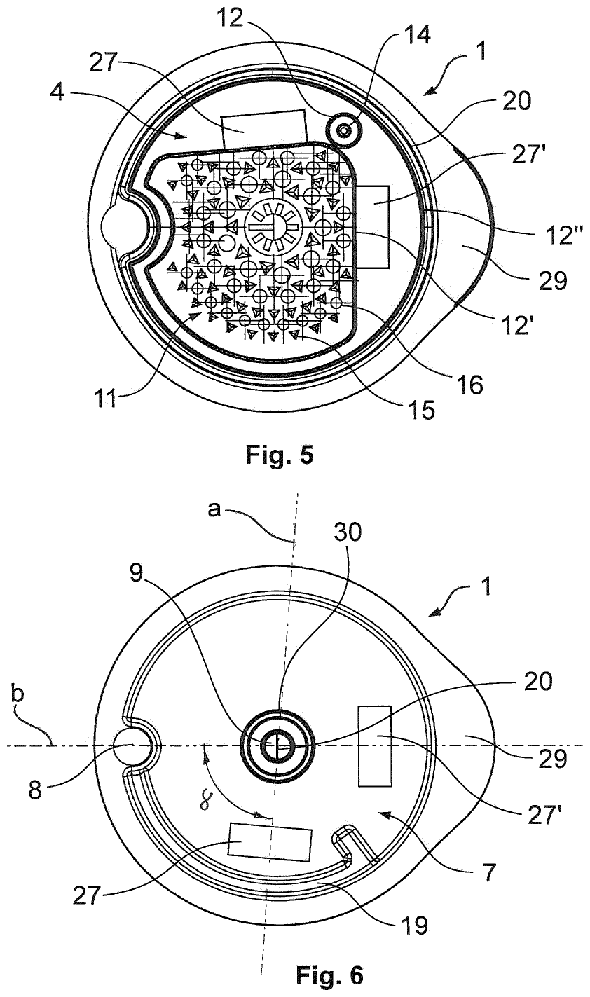

FIG. 5 shows details of the capsule side 4 of an adapter 1 for use with a capsule 2 according to the invention. It can be seen that the adapter 1 has a substantially circular shape and a tab 29. The tab 29 serves firstly as a gripping element for a user and secondly for aligning the adapter 1 in a beverage preparation device 3. The capsule side 4 of the adapter 1 has a discharging region 11. The discharging region 11 is surrounded by a sealing element 12′. Furthermore, a hollow canular 14 as a means for introducing a liquid into a capsule 2 is arranged on the capsule side 4. The hollow canular 14 is surrounded by a sealing element 12. The discharging region 11 has a multiplicity of penetration elements in the form of triangular pyramids 15. In addition to said pyramids 15, supporting elements in the form of truncated cones 16 are also arranged in the discharging region 11. For the positioning of a capsule 2 on the adapter 1, the latter has an encircling collar 20. Furthermore, there are two transparent regions 27, 27′ through which a code on the contact surface 13 of a capsule 2 placed onto the adapter 1 can be machine-read from the device side of the adapter 1.

FIG. 6 shows the device side 7 of the adapter 1 according to FIG. 5 with the transparent regions 27, 27′. Furthermore, the outlet 9 which is surrounded by an encircling collar 30 can be seen. The inlet 8 of the adapter 1 is arranged in the periphery thereof and opens into a duct 19, of which only the outer contour is visible in the present figure. The transparent region 27 is arranged in such a manner that the line a which connects the outlet 9 to the center of the transparent region 27 and a line b which connects the inlet 8 to the outlet 9 are separated by an angle spacing γ of 85°.

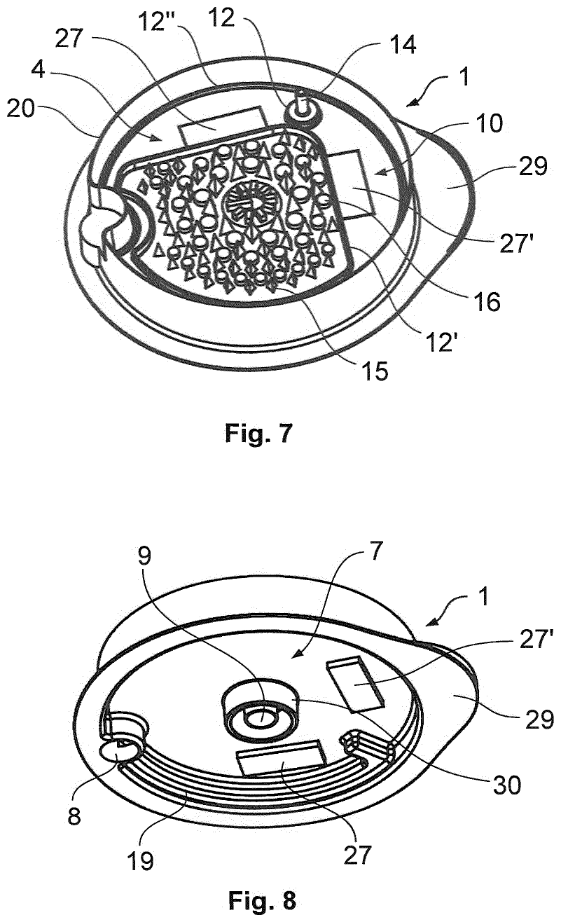

FIGS. 7 and 8 additionally also show the capsule side and device side of the adapter 1 in a perspective illustration. It can be seen that the adapter 1 is substantially disk-shaped.

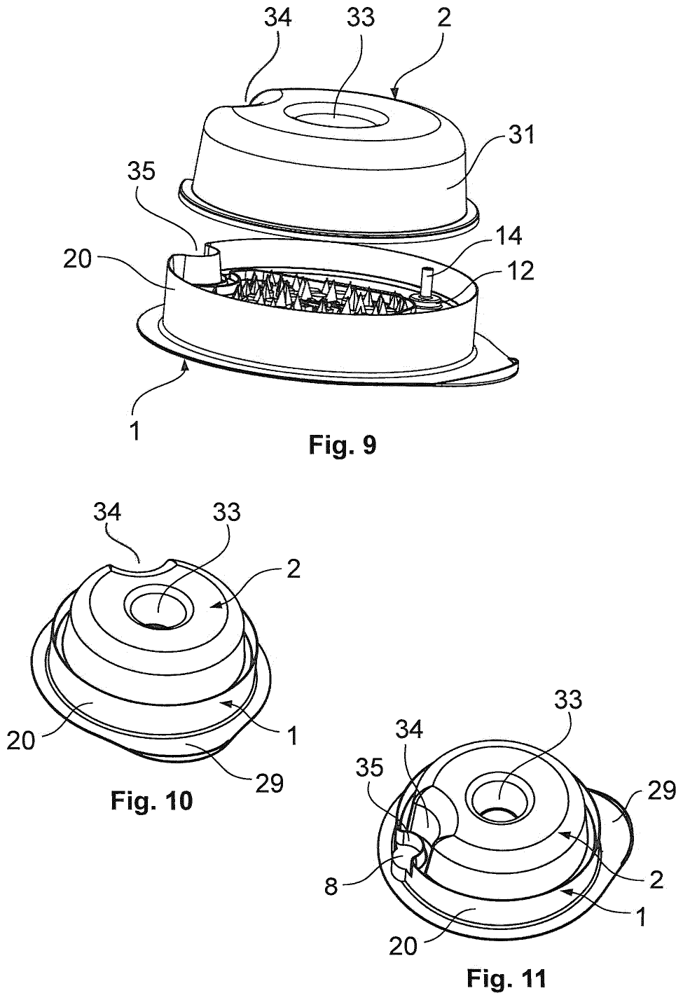

FIG. 9 shows the capsule 2 according to the invention and an adapter 1 provided for use therewith in an overall view. It can be seen that the recess 34 of the capsule 2 corresponds to an indentation 35 of the encircling collar 20 of the adapter 1. Therefore, in addition to an exact positioning of the capsule 2 on the adapter 1, a desired orientation of said capsule is also obtained.

In FIGS. 10 and 11, the capsule 2 is placed onto the adapter 1. It can be seen in particular in FIG. 11 that the recess 34 of the capsule 2 and the indentation 35 of the encircling collar of the adapter 1 also provide the required space for the inlet 8.

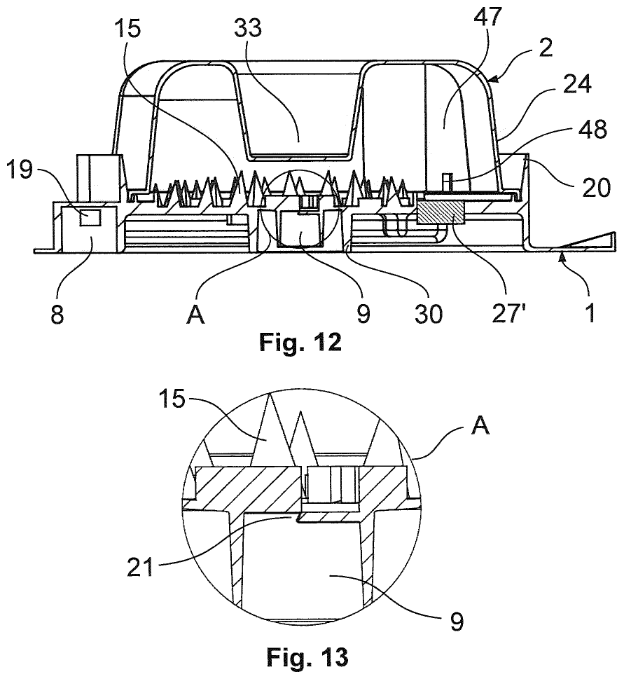

FIG. 12 shows a sectional view of the capsule 2 placed onto the adapter 1. For better clarity, the cover 25 of the capsule 2 has been omitted. The sectional plane runs along the straight line b (cf. FIG. 6) through the inlet 8, the outlet 9 and the transparent region 27′ of the adapter 1. In the present illustration, it can readily be seen that the inlet 8 opens into the duct 19. It can likewise be seen that the transparent region 27′ is formed by a cuboid element made from a transparent material which is inserted into a recess in the adapter 1.

FIG. 13 shows more precise details of the partial region A of FIG. 11. It can be seen that the opening for the liquid into the outlet 9 is designed as a gap 21. During the preparation of coffee beverages, said gap produces a crema typical of an espresso. Furthermore, the gap 21 carries out a valve function and can thus prevent an unintentional dripping of liquid after a beverage has been prepared when the capsule together with the adapter is removed from the beverage preparation device. A pyramid-shaped penetration element 15 can likewise be clearly seen in FIG. 12.

FIG. 14 shows an alternative sectional view of a capsule 2 according to FIGS. 12 and 13 placed onto an adapter 1. In this case, the sectional plane runs along the straight a, which runs vertically perpendicularly to the straight line b (cf. FIG. 6). The transparent region 27′ is correspondingly apparent here. Furthermore, a further portion of the duct 19 can be seen.

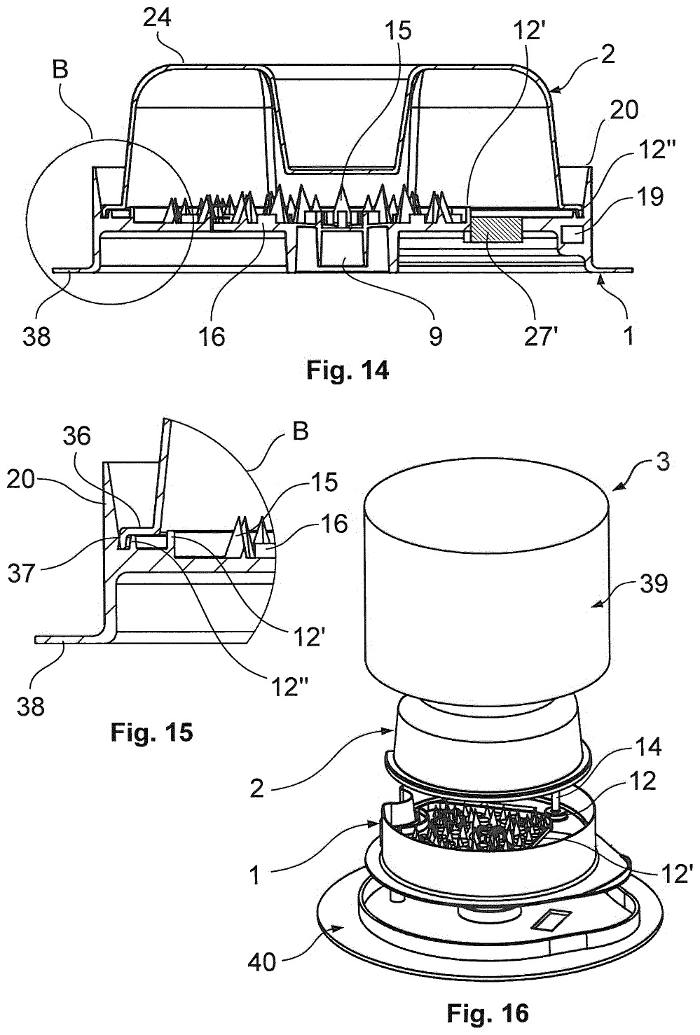

FIG. 15 shows an enlargement of the partial region B according to FIG. 14. It can be seen that the capsule body 24 comprises a flange-like edge 36. An outer region of the latter has an encircling collar 37 which runs substantially parallel to the side wall 31 and extends beyond the contact surface 13. When the capsule 2 is placed onto the adapter 1, the collar 37 engages in a groove formed by the encircling collar 20 and the sealing element 12″ of the adapter 1. The collar 20 of the capsule body 24 enters into a tight connection with the adapter 1. At the same time, the sealing element 12″ enters into a tight connection with the capsule body 24. The cover 25 of the capsule 2 is omitted in FIGS. 14 and 15. However, it is envisaged attaching such a cover in a centered manner on the flange-like edge 36 of the capsule body 24 such that said cover does not fall between the sealing element 12″ and the capsule body 24 or between the collar 37 and the adapter 1. It has been shown that this would significantly reduce the sealing action. In the case of the exemplary embodiment shown, it is provided that the cover 25 of the capsule 2 additionally enters into a tight connection with the sealing element 12′.

FIG. 16 shows a three-dimensional overall view of a capsule 2 according to the invention, of an adapter 1 and of the upper part 39 and the lower part 40 of a capsule holder of a beverage preparation device 3.

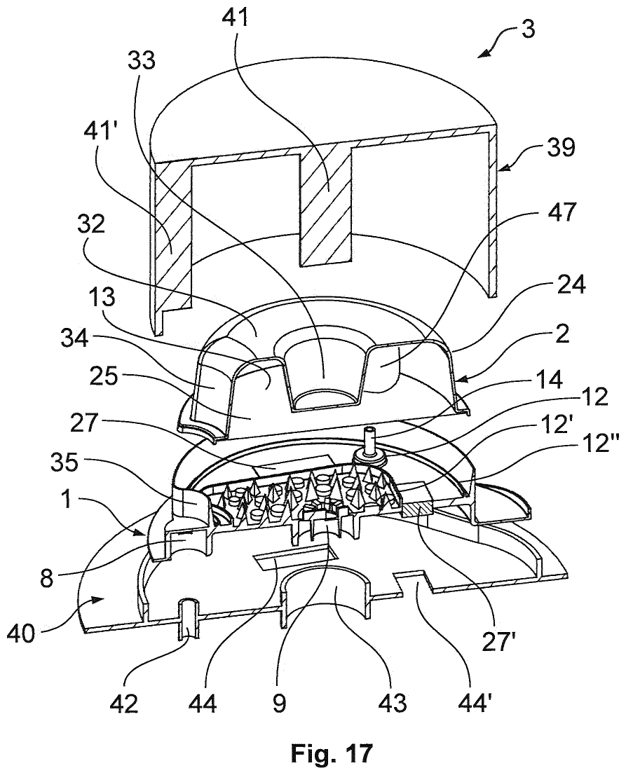

FIG. 17 shows a perspective sectional view of the overall view according to FIG. 16. It can be seen that the upper part 39 of the capsule holder has two punches 41, 41′. The punch 41 engages from the lower side in the elevation 31 of the base 32 of the capsule 2. The punch 41′ engages in the indentation 35 of the encircling collar 20. The lower part 40 of the capsule holder has an inflow stub 42 which engages in the inlet 8 of the adapter 1 and via which a pressurized liquid can be provided. Furthermore, the lower part 40 of the capsule holder has an outflow stub 43 in which the outlet 9 of the adapter 1 can engage. The lower part 40 of the capsule holder furthermore has two windows 44, 44′ via which a reading device, which is part of the beverage preparation device 3, can read a machine-readable code, which is mounted on the contact surface 13 of the capsule 2, for example a barcode 28, 28′, through the adapter 1.

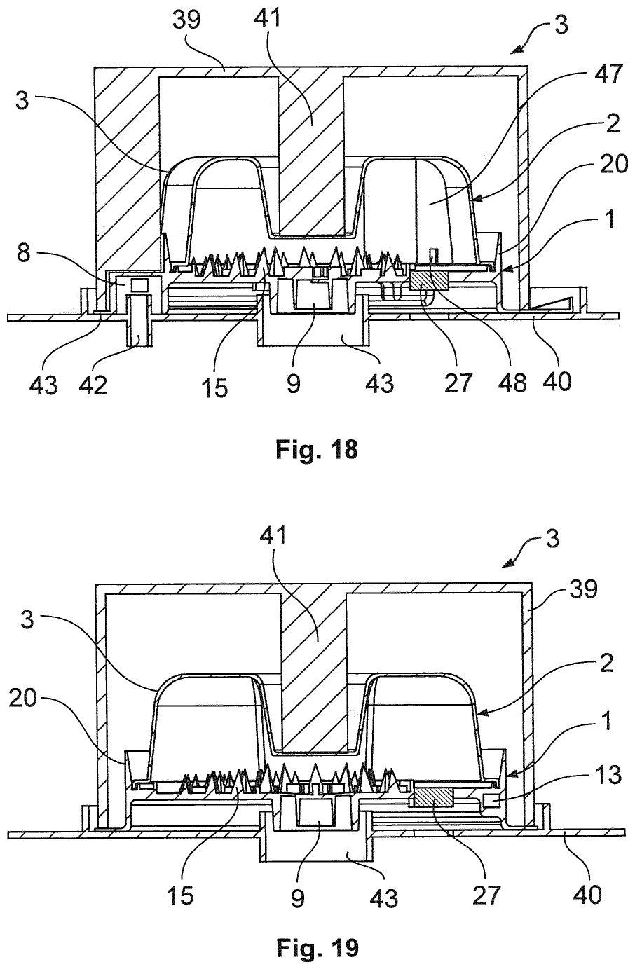

FIGS. 18 and 19 show the adapter 1 according to the invention with a capsule 2 in the capsule holder 39, 40 of a beverage preparation device 3 in the closed state. It can be seen that the flange-like edge 38 of the adapter 1 is clamped between the upper part 39 and the lower part 40 of the capsule holder, and therefore the latter is closed in a sealing manner. Furthermore, it can be seen how the punch 41 acts on the lower side of the elevation 33 in the capsule base 32. The capsule 2 is thus pressed onto the adapter 1, and therefore the sealing elements 12, 12′, 12″ and the encircling collar 37 together with the contact surface 13 of the capsule 2 close in a sealing manner. Furthermore, the punch 41′ presses onto the inlet 8 of the adapter 1. The transition from the inflow stub 42 to the inlet 8 is thus sealed. For better clarity, the cover 25 forming the contact surface 13 is omitted in FIGS. 18 and 19.

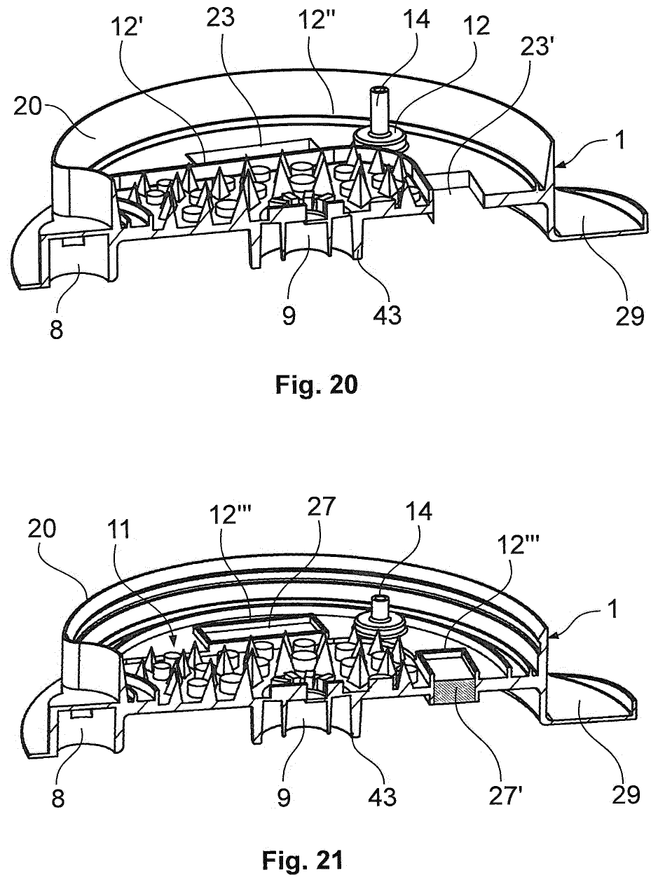

FIG. 20 shows an alternative embodiment of an adapter 1. The latter has windows 23, 23′ through which a machine-readable code mounted on the contact surface 13 of the capsule 2 can be read by the beverage preparation device 3 when the adapter 1 is placed together with the capsule 2 into the beverage preparation device 3.

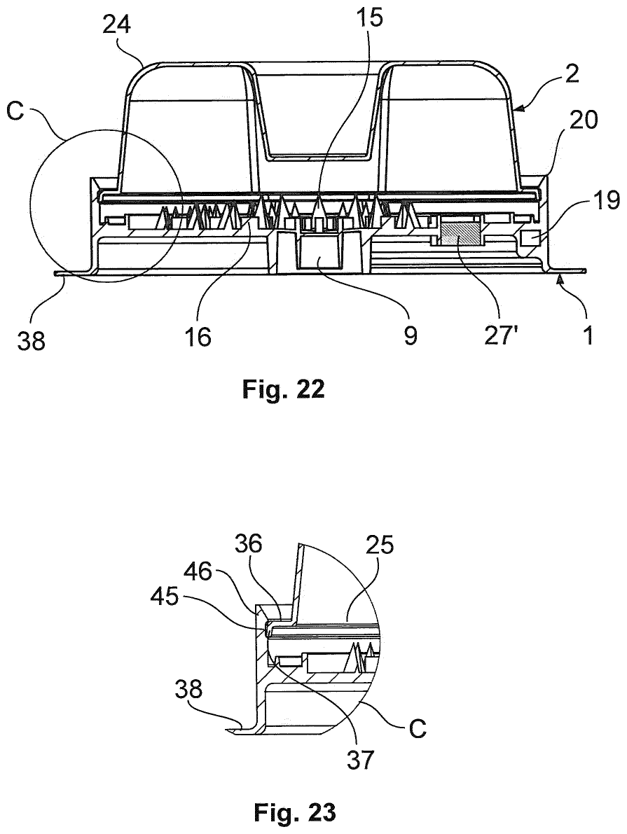

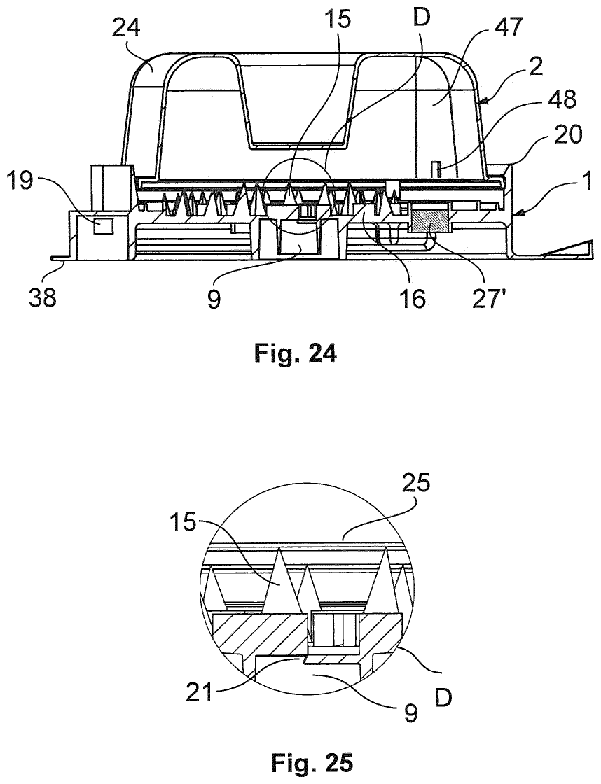

FIGS. 21 to 25 show a further exemplary embodiment of an adapter 1. The latter is used in the example according to FIGS. 5 to 19. However, a sealing element 12′ is not arranged around the discharging region 11. Instead, the transparent regions 27, 27′ are each surrounded by a sealing element 12″'. An adapter which has both sealing elements 12′, which surround the discharging region 11, and sealing elements 12″', which surround the transparent regions 27, 27′ or windows 23, 23′, would also be conceivable.

As is apparent in particular from FIG. 23, in said exemplary embodiment, the encircling collar 20 of the adapter 1 has latching means in the form of a cavity 45 and a latching lug 46, to which the encircling collar 37 of the flange-like edge 36 of the capsule body 24 can be latched. The capsule 2 can thus be held in a standby position in which the contact surface 13 of the capsule, formed in the present case by the cover 25, is held in front of the above-described penetration elements. The cover 25 is penetrated only when the capsule 2 and the adapter 1 are placed into the beverage preparation device 3 and the device 3 is closed.

1-15. (canceled)

16. A capsule for preparing a beverage product, comprising:
a capsule body,
a cover, and
an inlet for introducing a fluid into the capsule,
wherein the capsule body is covered by the cover in order to form a closed receiving space, and the inlet is arranged o′n the capsule eccentrically with respect to a center of the cover,
a first machine readable code is mounted eccentrically on the cover,
the first machine readable code is arranged with respect to the center of the cover at an angle spacing from the inlet, and
the angle spacing has a value of at most 70°.

17. The capsule according to claim 16, wherein a second machine readable code is mounted eccentrically on the cover next to the first machine readable code, the first machine readable code is arranged with respect to the center of the cover at a positive angle spacing and the second machine readable code is arranged at a negative angle spacing from the inlet, and the angle spacings have a value of at most 70°.

18. The capsule according to claim 17, wherein the value of the first and second angle spacing is identical in size.

19. The capsule according to claim 16, wherein the capsule body has a recess in an edge region, and the angle spacing of the recess from the inlet with respect to the center of the cover has a value of at least 90°.

20. The capsule according to claim 1$, wherein the inlet is arranged in an interior of the receiving space.

21. The capsule according to claim 20, wherein the inlet is dosed by the cover.

22. The capsule according to claim 16, wherein at least one machine readable code is a one dimensionally machine readable code.

23. The capsule according to claim 16, wherein at least one machine readable code contains parameters for preparing the beverage product and/or is linked to said parameters.

24. The capsule according to claim 23, wherein at least one machine readable code contains at least one beverage preparation routine and/or is linked thereto.

25. The capsule according to claim 16, wherein the cover is formed from a composite structure.

26. The capsule according to claim 16, wherein the capsule body is produced from a plastics material.

27. The capsule according to claim 16, wherein the capsule body and the cover are oxygen and/or aroma tight.

28. A beverage preparation system comprising a capsule according to claim 16 and a beverage preparation machine, wherein the beverage preparation machine has a receptacle with at least one reading device, and the capsule is inserted into the receptacle and at least one machine readable code is read using said at least one reading device.

29. The beverage preparation system according to claim 28, wherein the reading device is designed as at least one barcode scanner or as a camera system.

30. The beverage preparation system according to claim 28, additionally comprising an adapter, wherein, in order to introduce a liquid into the capsule and in order to discharge a liquid from the capsule, the adapter is placed together with said capsule into the beverage preparation device.

31. A kit comprising at least one capsule according to claim 16 and at least one adapter, wherein the adapter is placed together with the capsule into a beverage preparation machine, in order to introduce a liquid into the capsule and in order to discharge a liquid from the capsule.
